(19) United States
(12) Patent Application Publication
(10) Pub. No.: US 2005/0246896 A1
(43) Pub. Date: Nov. 10, 2005

(54) Initial setting method of refrigerant entrance/exit (inlet/outlet) pipe onto header pipe for heat exchanger

(76) Inventor: Kyung Geun Min, Chunan-city (KR)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/117,095

(22) Filed: Apr. 28, 2005

(30) Foreign Application Priority Data
Apr. 28, 2004 (KR) 2004-0029530

(51) Int. Cl. F28D 1/00; B23P 11/00

(52) U.S. Cl. 29/890.036; 29/512; 29/509; 29/890.03

(57) ABSTRACT

The present invention relates to a method for the initial setting of a refrigerant inlet/outlet pipe onto a header pipe for a heat exchanger to improve the initial setting property and the brazing junction property of the refrigerant inlet/outlet pipe with respect to the header pipe. The method utilizes a support board that is installed through the refrigerant tube connection holes to support and press a pipe expanding tool which deforms an end of the refrigerant inlet/outlet pipe on an interior side of the header pipe.

### FIELD OF THE INVENTION

The present invention relates to a technology in the air conditioner heat exchanger field. In particular, it relates to the initial setting before the brazing of the refrigerant inlet/outlet pipe onto a header pipe which is used for the heat exchanger and refrigerant tube connection.

### BACKGROUND OF THE INVENTION

A vehicle air conditioner heat exchanger, such as a condenser, consists of many refrigerant tubes so that the refrigerant which is a medium for a heat exchange can perform on the inside of the heat exchanger effectively with the outside air. These refrigerant tubes' end parts are connected by the header pipe which forms the flow route for the flow.

One side of the header pipe is assembled with a refrigerant inlet/outlet pipe for the entrance and exit of the refrigerant. Generally, the complete connection of the header pipe and the refrigerant inlet/outlet (inlet or outlet) pipe is accomplished when the refrigerant inlet/outlet pipe is assembled to the header pipe on the opposite side of the refrigerant tube, at which time the brazing is done to other parts while it is covered with the clad materials.

Specifically, a refrigerant inlet/outlet pipe initial setting is achieved, as shown in the attached FIG. 1, by forming the refrigerant inlet/outlet pipe setting hole (100b) on the header pipe (100), on the opposite side of the refrigerant tube connecting hole (100a), and then by inserting one end of the refrigerant inlet/outlet pipe (200) into the setting hole (100b). At this time, a separate washer (210) is inserted on the end of the refrigerant inlet/outlet pipe (200), so that the outside of the setting hole (100b) of the header pipe's (100) exterior wall is in contact. Hence, the brazing washer (210) is connected to the surface of the header pipe (100). In addition, the other end of the refrigerant inlet/outlet pipe (200) is attached to the header pipe (100) having a bracket (300).

However, as stated above, in the former method in the refrigerant inlet/outlet pipe initial setting, one end part of the refrigerant inlet/outlet pipe (200) is inserted into the setting hole (100b) of the header pipe (100). In this state, the washer (210) is connected to the setting area by brazing. During this brazing process, the setting condition of the header pipe's (100) refrigerant inlet/outlet pipe (200) and the washer (210) is not maintained properly, thus causing the problems of incomplete brazing connection.

### SUMMARY OF THE INVENTION

The invention has been developed to improve the existing problems. The invention's purpose is to provide an improved initial setting method and brazing connection for the refrigerant inlet/outlet pipe onto the header pipe for the heat exchanger.

To achieve the above purpose, in one form, the present invention's initial setting method of the refrigerant inlet/outlet pipe onto the header pipe for heat exchanger is comprised of: a first step in which (1) a refrigerant inlet/outlet pipe assembly hole is formed at the opposite side of the refrigerant tube connection hole on the header pipe. In addition, a bead is formed at the upper end of the refrigerant inlet/outlet pipe, which is attached to the assembly hole following the header pipe's curvature; a second step, in which (2) an end part of the refrigerant inlet/outlet pipe is inserted into the assembly hole; a third step, in which (3) a pipe expanding tool is inserted inside the header pipe in the direction of the end of the refrigerant inlet/outlet pipe; a fourth step in which (4) a support board supporting the pipe expanding tool is installed through the refrigerant tube connection hole, and a compressor, which is capable of compressing the bead onto the exterior wall of the header pipe is installed; a fifth step in which (5) the end part of the refrigerant inlet/outlet pipe is expanded by pressing the pipe expanding tool through the support board; and a sixth step in which (6) the support board and the pipe expanding tool are removed.

In accordance with one feature of the invention, a method is provided for initially connecting a refrigerant inlet/outlet pipe to a header pipe for a heat exchanger. The method includes the steps of: forming a refrigerant inlet/outlet pipe assembly hole in a header pipe opposite from at least one refrigerant tube connection hole in the header pipe; providing an inlet/outlet pipe having a bead formed at a location spaced from an end of the refrigerant inlet/outlet pipe, the bead shaped to conform to an exterior surface of the header pipe adjacent the assembly hole; inserting the end of the refrigerant inlet/outlet pipe into the assembly hole; inserting a pipe expanding tool into the interior of the header pipe through an open end of the header pipe and directing the pipe expanding tool to be received in the end of the refrigerant inlet/outlet pipe; supporting the pipe expanding tool with a support board that is inserted through the at least one refrigerant tube connection hole in the header pipe; supporting the bead against the exterior of the header pipe; expanding the end of the refrigerant inlet/outlet pipe by pressing the pipe expanding tool through the support board; and removing the support board and the pipe expanding tool from the header pipe.

Other objects, features, and advantages of the invention will become apparent from a review of the entire specification, including the appended claims and drawings.

### BRIEF DESCRIPTION OF THE DRAWINGS

FIG. 1 illustrates the initial setting of a header pipe and refrigerant inlet/outlet pipe which are assembled according to a prior art methods in perspective view;

FIG. 2 is a sectional view illustrating the insertion of an end of the refrigerant inlet/outlet pipe into a header pipe setting hole according to the present invention;

FIG. 3 illustrates the state immediately before the end of the refrigerant inlet/outlet pipe becomes expanded according to the present invention; and

FIG. 4 illustrates the state in which the end of the refrigerant inlet/outlet pipe becomes expanded according to the present invention.

### DETAILED DESCRIPTION OF THE PREFERRED EMBODIMENT

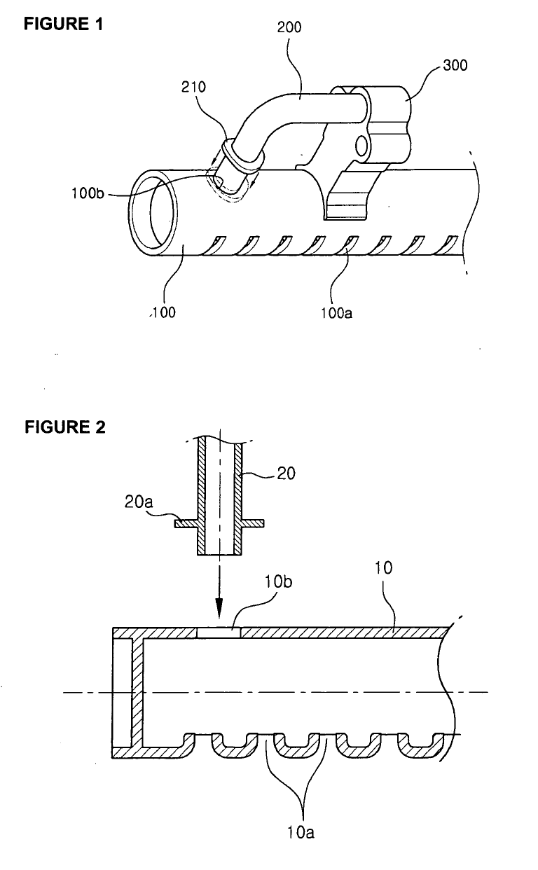

First, as shown in FIG. 2, the refrigerant tube connection holes (10a) are made at one side of the header pipe (10), and an assembly hole is made at the opposite side of these connection holes (10a) for the refrigerant inlet/outlet pipe (20) assembly. In addition, at the upper end of refrigerant inlet/outlet pipe (20), a bead (20a) is made by following the header pipe's (1 0) curvature. It is desirable to make this bead (20a) at the same time that the refrigerant inlet/outlet pipe (20) is made, and this bead (20a) replaces the previously used washer (210).

Then, as in FIG. 1, an end part of the refrigerant inlet/outlet pipe (20) is inserted onto the header pipe (10)'s refrigerant inlet/outlet pipe assembly hole (10b). At this time, the bead (20a) at the refrigerant inlet/outlet pipe (20) should be closely conforming to the exterior surface of header pipe (10).

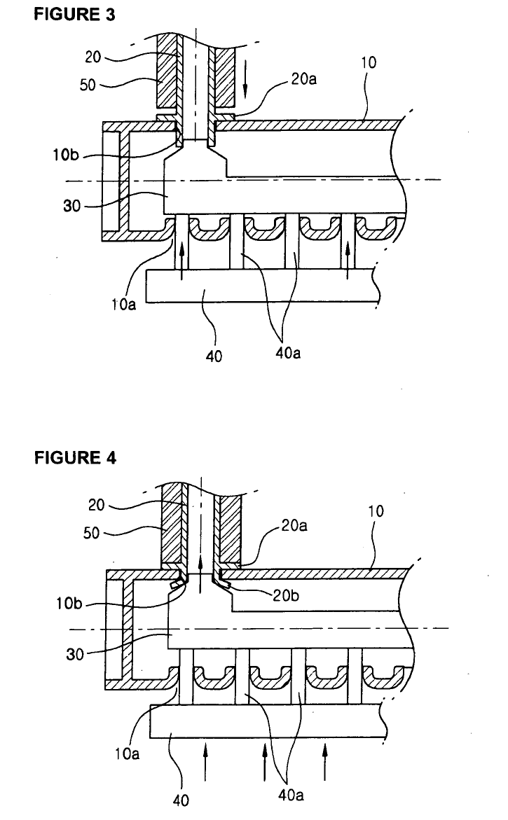

Next, as shown in FIG. 3, an expanding tool (30) is inserted into the header pipe (10). The front of the expanding tool (30) must directly face the end part of the refrigerant inlet/outlet pipe (20).

Then, a supporting board (40) is installed from the bottom of the header pipe (10) to support the expanding tool (30). The supporting board (40) includes and holds many supporting posts (50a) in matching spaces with the refrigerant tube connection holes (10a) and is able to support the lower side of the expanding tool (30) through the header pipe's (10) connection holes (10a).

In addition, to prevent the movements of the bead (20a) at the refrigerant inlet/outlet pipe (20), which is located to the outside of the refrigerant inlet/outlet pipe assembly hole (10b) on the header pipe (10), the bead (20a) is compressed to the exterior wall of the header pipe (10) using a compressor (50).

Next, as shown in FIG. 4, the supporting board (40) is pushed up, pressing the expanding tool (30), and the expanding tool (30) expands the end of the refrigerant inlet/outlet pipe (20). Consequently, an expanding part (20b) is formed in the interior wall of the header pipe (10) at the end of the refrigerant inlet/outlet pipe (20). The expanding part (20b) and the bead (20a), which is compressed to the exterior wall of header pipe (10), keeps the refrigerant inlet/outlet pipe (20) inside/outside of the wall of header pipe (10) firmly fixed.

In this manner, when the expanding part (20b) is completed, the supporting board (40) is lowered and the expanding pipe tool (30) is removed from the inside of the header pipe (10), hence, the initial setting of refrigerant inlet/outlet pipe (20) onto the header pipe (10) is completed, at which time the brazing can be finished.

As described before, in the present invention, the bead (20a) is compressed to the exterior wall of the header pipe (10), uniting with the end part of the refrigerant inlet/outlet pipe (20), while the expanding pipe (20b) adheres to the interior wall of the header pipe (10). Thus, the initial setting of the refrigerant inlet/outlet pipe (20) onto the header pipe (10) is maintained extremely firm and the connection in the following brazing process is excellent.

As explained before, the present invention's initial setting of the refrigerant inlet/outlet pipe (20) onto the header pipe (10) for a heat exchanger improves the initial setting of the refrigerant inlet/outlet pipe onto the header pipe and the brazing connection, which is effective in the conservation of the heat exchanger's functioning.

1. A method for initially connecting a refrigerant inlet/outlet pipe to a header pipe for a heat exchanger; the method comprising the steps of:
forming a refrigerant inlet/outlet pipe assembly hole in a header pipe opposite from at least one refrigerant tube connection hole in the header pipe;
providing an inlet/outlet pipe having a bead formed at a location spaced from an end of the refrigerant inlet/outlet pipe, the bead shaped to conform to an exterior surface of the header pipe adjacent the assembly hole;
inserting the end of the refrigerant inlet/outlet pipe into the assembly hole;
inserting a pipe expanding tool into the interior of the header pipe through an open end of the header pipe and directing the pipe expanding tool to be received in the end of the refrigerant inlet/outlet pipe;
supporting the pipe expanding tool with a support board that is inserted through the at least one refrigerant tube connection hole in the header pipe;
supporting the bead against the exterior of the header pipe;
expanding the end of the refrigerant inlet/outlet pipe by pressing the pipe expanding tool through the support board; and
removing the support board and the pipe expanding tool from the header pipe.
